(19) United States
(12) Patent Application Publication
(10) Pub. No.: US 2010/0288047 A1
(43) Pub. Date: Nov. 18, 2010

(54) MEMS SENSOR AND ELECTRONIC APPARATUS

(75) Inventor: Shigekazu TAKAGI, Shimosuwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/778,498

(22) Filed: May 12, 2010

(30) Foreign Application Priority Data
May 15, 2009 (JP) 2009-118343
Mar. 16, 2010 (JP) 2010-058819

(51) Int. Cl. G01P 15/125

(52) U.S. Cl. 73/514.32

(57) ABSTRACT

A MEMS sensor includes: a supporting portion; a movable weight portion; a connecting portion that couples the supporting portion with the movable weight portion and is elastically deformable; a first fixed electrode portion protruding from the supporting portion; and a first movable electrode portion protruding from the movable weight portion and disposed so as to face the first fixed electrode portion, wherein the movable weight portion is formed by stacking a conductive layer and an insulating layer in a first direction, plugs having a larger specific gravity than the insulating layer are embedded in the insulating layer, the conductive layer is connected to the first movable electrode portion, and one of the first fixed electrode portion and the first movable electrode portion has a first electrode portion and a second electrode portion in the first direction.

### BACKGROUND

1. Technical Field

The present invention relates to a MEMS sensor (Micro Electro Mechanical Systems), an electronic apparatus, and the like.

2. Related Art

As a silicon MEMS acceleration sensor with a CMOS integrated circuit for example, a reduction in size and cost for this type of MEMS sensor is rapidly progressing. The application and market of the MEMS sensor are expanding. In a main device form, an IC chip that converts a physical quantity into an electric signal and outputs the same is made into one package by a mounting process after a wafer process in most cases. For achieving an extreme reduction in size and cost, a technique of integrally forming a sensor chip and an IC chip by a wafer process is required (refer to JP-A-2006-263902).

In JP-A-2006-263902, a movable electrode portion is displaced in a Z-direction that is perpendicular to a substrate, and a physical quantity such as acceleration is detected based on a capacitance change due to a change in distance between electrodes of the movable electrode portion and a fixed electrode portion (refer to paragraph 0044).

On the other hand, a sensor has been known in which first and second fixed electrode portions whose facing areas relative to the movable electrode portion that is displaced in the Z-direction change are provided (JP-A-2004-286535).

This type of MEMS sensor has such characteristics that sensitivity is enhanced as the mass of a movable weight portion in which the movable electrode portion is provided increases. For increasing the mass of the movable weight portion, in JP-A-2006-263902, the movable weight portion is formed of an integral structure including multi-layer wiring that is formed simultaneously with a multi-layer wiring layer of an LSI (paragraph 0089 and FIG. 25).

The movable weight portion is formed only of the wiring layer. Since all inter-layer insulating layers are removed, the once formed inter-layer insulating layers cannot be used as a weight. The same exactly applies to JP-A-2004-286535 in which silicon oxide films and polysilicon layers to be patterned are alternately formed by two layers each, that is, four layers in total on a silicon substrate, and thereafter all the two layers of silicon oxide films are removed by etching to form the movable weight portion (paragraph 0027).

### SUMMARY

An advantage of some aspects of the invention is to provide a MEMS sensor (for example, electrostatic capacitive acceleration sensor) in which the mass of a movable weight portion capable of moving in a direction perpendicular to a substrate can be efficiently increased, to provide a MEMS sensor that can detect a physical quantity such as acceleration with high accuracy, for example, and to provide a MEMS sensor that can be manufactured freely and easily by using a CMOS process in which multi-layer wiring is used, for example.

An aspect of the invention relates to a MEMS sensor including: a movable weight portion including a movable electrode portion; a supporting portion disposed around the movable weight portion via a first gap portion; a fixed electrode portion having a facing-electrode face that faces a movable-electrode face of the movable electrode portion via the first gap portion; and an elastically deformable connecting portion that supports the movable weight portion by coupling to the supporting portion and varies the facing area between the facing-electrode face and the movable-electrode face. The movable weight portion has a stacked structure including a plurality of conductive layers, a plurality of inter-layer insulating layers disposed between the plurality of conductive layers, and a plug that is filled into an embedding groove pattern formed to penetrate through the respective plurality of inter-layer insulating layers and has a larger specific gravity than the inter-layer insulating film. The plug formed in the layers includes a wall portion formed in a wall shape along at least one axial direction on a two-dimensional plane parallel to the plurality of inter-layer insulating layers, and the movable weight portion moves in a Z-direction in which the layers are stacked in the stacked structure. In one embodiment, a MEMS sensor includes: a supporting portion; a movable weight portion; a connecting portion that couples the supporting portion with the movable weight portion and is elastically deformable; a first fixed electrode portion protruding from the supporting portion; and a first movable electrode portion protruding from the movable weight portion and disposed so as to face the first fixed electrode portion. The movable weight portion is formed by stacking a conductive layer and an insulating layer in a first direction, plugs having a larger specific gravity than the insulating layer are embedded in the insulating layer, the conductive layer is connected to the first movable electrode portion, and one of the first fixed electrode portion and the first movable electrode portion has a first electrode portion and a second electrode portion in the first direction. Moreover, a MEMS sensor includes: a supporting portion; a movable weight portion; a connecting portion that couples the supporting portion with the movable weight portion and is elastically deformable; a first fixed electrode portion protruding from the supporting portion; a first movable electrode portion protruding from the movable weight portion and disposed so as to face the first fixed electrode portion. The movable weight portion is formed by stacking a conductive layer and an insulating layer in a first direction, plugs having a larger specific gravity than the insulating layer are embedded in the insulating layer, the conductive layer is connected to the first movable electrode portion, and the first fixed electrode portion and the first movable electrode portion have a facing region where electrodes face each other and a non-facing region where electrodes do not face each other.

According to the aspect of the invention, the movable weight portion that is supported by coupling to the supporting portion via the connecting portion includes the movable electrode portion. Based on the fact that the facing area between the movable-electrode face of the movable electrode portion and the facing-electrode face of the fixed electrode portion changes, the magnitude and direction of a physical quantity in the Z-direction perpendicular to the facing-electrode face can be detected from the relation of the magnitude of a capacitance depending on the facing area. In this case, the movable weight portion that can increase sensitivity as the mass thereof increases can be formed as the stacked structure having the plurality of conductive layers, the plurality of inter-layer insulating layers, and the plugs formed in the inter-layer insulating layers. Especially the plug greatly contributes to an increase in the mass of the movable weight portion because a member having a larger specific gravity than the inter-layer insulating layer is used for the plug.

Since the stacked structure constituting the movable weight portion can be formed by a typical CMOS process, the MEMS sensor can easily coexist with an integrated circuit portion on the same substrate. Moreover, since a multi-layer conductive layer is relatively easily formed, the degree of design freedom is high. For example, the demand for higher sensitivity of an acceleration sensor can be met by increasing the number of layers and increasing the mass of the movable weight portion. Moreover, since the movable electrode portion can be formed by using a part or entire of the plurality of conductive layers stacked in the Z-direction in the stacked structure and the plugs in the layers for connecting the conductive layers, any special step is not required.

In the aspect of the invention, also the fixed electrode portion can include the same cross-sectional structure as at least a part of the stacked structure. The first fixed electrode portion and the first movable electrode portion are formed by using the conductive layer and the insulating layer. The plugs are embedded in the insulating layer in the first direction, and the plugs are conductive members. That is, since also the fixed electrode portion can be formed by using a part or entire of the plurality of conductive layers stacked in the Z-direction in the stacked structure and the plugs in the layers for connecting the conductive layers, any special step is not required.

In the aspect of the invention, one of the fixed electrode portion and the movable electrode portion can include first and second electrode portions electrically insulated from each other in the Z-direction. With this configuration, a direction of displacement of the movable weight portion can also be detected based on a change in facing area of one of the first and second electrode portions or the relation of increase and decrease in facing areas of both the first and second electrode portions.

In the aspect of the invention, the first and second electrode portions are electrically insulated from each other in the Z-direction by one of the plurality of inter-layer insulating layers. To this end, it is sufficient that the plug is not formed between the first and second electrode portions in the one inter-layer insulating layer. This makes it possible to easily isolate the first and second electrode portions from each other in the Z-direction.

In one embodiment, the movable weight portion has a first face whose normal line is in the first direction, and the plugs are formed to be line-symmetric with respect to both a second direction parallel to the first face and a third direction parallel to the first face and orthogonal to the second direction. With such a configuration, the movable balance of the movable weight portion can be kept when force is applied from the outside, and therefore detection sensitivity can be further improved.

In the aspect of the invention, the MEMS sensor can be configured such that when the movable weight portion is displaced in the Z-direction, while the facing area of one of the first and second electrode portions increases, the facing area of the other of the first and second electrode portions decreases. To this end, it is sufficient that only a part of electrode face of the first and second electrode portions contributes to the facing area when the movable weight portion is stopped. Specifically, for example, it is sufficient that an upper end of the first electrode portion protrudes higher than an upper end of the facing electrode portion (the other of the fixed electrode portion and the movable electrode portion), and a lower end of the second electrode portion protrudes lower than a lower end of the facing electrode portion.

In the aspect of the invention, the MEMS sensor may be configured such that one of the fixed electrode portion and the movable electrode portion includes first and second electrode portions facing one face of the other of the fixed electrode portion and the movable electrode portion and electrically insulated from each other in the Z-direction and third and fourth electrode portions facing the other face of the other of the fixed electrode portion and the movable electrode portion and electrically insulated from each other in the Z-direction, the first and third electrode portions are formed by using a part of the plurality of conductive layers and the plugs in the layers, the second and fourth electrode portions are formed by using another part of the plurality of conductive layers and the plugs in the layers, the first and fourth electrode portions are electrically connected to each other, and the second and third electrode portions are electrically connected to each other.

With this configuration, even in the case where the thicknesses of the plurality of conductive layers and the plurality of inter-layer insulating layers are different, the total facing area of the first and fourth electrode portions connected to each other and the total facing area of the second and third electrode portions connected to each other can be made equal to each other when the movable weight portion is stopped.

In the aspect of the invention, the MEMS sensor further includes a substrate on which the stacked structure is formed, and an integrated circuit portion formed on the substrate. The plurality of conductive layers, the plurality of inter-layer insulating layers, and the plugs in the layers of the stacked structure can be manufactured by the manufacturing process of the integrated circuit portion. The integrated circuit portion is formed next to the supporting portion, and the integrated circuit portion is formed by using the conductive layer and the insulating layer.

As described above, since the stacked structure of the movable weight portion is suitable for a CMOS process, the MEMS sensor can be mounted together with the integrated circuit portion on the same substrate. This makes it possible to reduce a manufacturing cost compared to the case of manufacturing and assembling the respective ones in different processes. Further, the CMOS integrated circuit portion and the MEMS structure are formed monolithically, so that the wiring distance can be shortened. Therefore, it can be expected that a loss component due to the routing of the wiring will be reduced, and that resistance to external noise will be improved.

In the aspect of the invention, the plurality of conductive layers can include the same layer as a gate electrode of a transistor formed in the integrated circuit portion. This makes it possible to effectively increase the mass of the movable weight portion. When the second movable electrode portion of the movable electrode portion includes a conductive layer of a gate electrode material (for example, a polysilicon layer), and the first movable electrode portion is formed only of a conductive layer including a metal wiring layer having a different thickness from that of the gate electrode material, the facing areas of the first and second electrode portions are not equal to each other in some cases when the movable weight portion is stopped. As described above in this case, the problem can be solved by further disposing the third and fourth electrode portions. When the plurality of conductive layers are formed of metal wiring layers above the gate electrode of the transistor formed in the integrated circuit portion, the thickness of the metal wiring layers can be made equal. Therefore, the facing areas of the first and second electrode portions can be made equal to each other when the movable weight portion is stopped. However, this is applicable when the metal wiring layers include plural layers of four or more layers because the gate electrode layer is not used as an electrode portion.

In the aspect of the invention, in addition to the Z-direction orthogonal to a two-dimensional plane parallel to the substrate, the connecting portion can movably support the movable weight portion in at least one direction of orthogonal two axes X and Y on the two-dimensional plane. The stacked structure of the movable weight portion can include a protruding movable electrode portion protruding in the at least one direction, and the supporting portion can have a protruding fixed electrode portion facing the protruding movable electrode portion. With this configuration, a physical quantity in one or both of the X- and Y-directions can be detected in addition to the Z-direction.

In the aspect of the invention, the MEMS sensor can include a fixed portion fixed to the substrate, a first movable weight portion that can move relative to the fixed portion via a first connecting portion, and a second movable weight portion that can move relative to the first movable weight portion via a second connecting portion. Moreover, the MEMS sensor includes electrode pairs including a second fixed electrode portion protruding from the supporting portion and a second movable electrode portion protruding from the movable weight portion and disposed so as to face the second fixed electrode portion as a pair. The movable weight portion has a rectangular parallelepiped shape having first and second faces whose normal lines are in the first direction and first to fourth side faces connected to the first and second faces, at least two of the electrode pairs are formed on the first side face, or at least each of the electrode pairs is formed on both the first side face and the second side face facing the first side face, and force in a direction parallel to the first and second side faces is detected based on the capacitance difference between two capacitance forming portions. Moreover, at least two of the electrode pairs are formed on the third side face orthogonal to the first side face, or at least each of the electrode pairs is formed on both the third side face and the fourth side face facing the third side face, and force in a direction parallel to the third and fourth side faces is detected based on the capacitance difference between two capacitance forming portions. In this case, when it is assumed that one of the first movable weight portion and the second movable weight portion serves as the movable weight portion, that one of the first connecting portion and the second connecting portion serves as the connecting portion, that one of the fixed portion and the first movable weight portion serves as the supporting portion, and that one of the first connecting portion and the second connecting portion deforms in the Z-direction orthogonal to the two-dimensional plane parallel to the substrate, a physical quantity in the Z-direction can be detected. In addition, it is assumed that the other of the first connecting portion and the second connecting portion deforms in at least one direction of orthogonal two axes X and Y on the two-dimensional plane. When the other of the first movable weight portion and the second movable weight portion includes a protruding movable electrode portion protruding in at least one direction of the orthogonal two axes X and Y on the two-dimensional plane, and the other of the fixed portion and the first movable weight portion has a protruding fixed electrode portion facing the protruding movable electrode portion, a physical quantity in one or both of the X- and Y-directions can be detected in addition to the Z-direction.

That is, when the second movable weight portion serves as a movable weight portion that is displaced in the Z-direction relative to the first movable weight portion (supporting portion), the second connecting portion functions as a connecting portion that elastically deforms in the Z-direction. In this case, the first movable weight portion is displaced in one or both of the X- and Y-directions with the first connecting portion relative to the fixed portion, contributing to the detection of a physical quantity in one or both of the X- and Y-directions. Conversely, when the first movable weight portion serves as a movable weight portion that is displaced in the Z-direction relative to the fixed portion (supporting portion), the first connecting portion functions as a connecting portion that elastically deforms in the Z-direction. In this case, the second movable weight portion is displaced in one or both of the X- and Y-directions with the second connecting portion relative to the first movable weight portion, contributing to the detection of a physical quantity in one or both of the X- and Y-directions.

In one embodiment, an electronic apparatus including the MEMS sensor may be provided. When the MEMS sensor according to the aspect of the invention is mounted on an electronic apparatus, an electronic apparatus having excellent detection sensitivity especially in the Z-direction can be provided.

### BRIEF DESCRIPTION OF THE DRAWINGS

The invention will be described with reference to the accompanying drawings, wherein like numbers reference like elements.

FIG. 1 is a schematic view of an acceleration sensor module according to a first embodiment of the invention.

FIG. 2 is a plan view of a sensor module having the same basic configuration as that of FIG. 1 but different in shape therefrom.

FIG. 3 is a cross-sectional view taken along line I-I of FIG. 2.

FIG. 4 is a horizontal cross-sectional view of plugs provided in a movable weight portion.

FIG. 5 is a block diagram of the acceleration sensor module.

FIGS. 6A and 6B explain the configuration and operation of a C/V conversion circuit (charge amplifier).

FIGS. 7A to 7D schematically show a manufacturing process of the acceleration sensor module according to the first embodiment of the invention.

FIG. 8 is a schematic view of an acceleration sensor module according to a second embodiment of the invention.

FIG. 9 is a schematic view of an acceleration sensor module according to a third embodiment of the invention.

FIG. 10 shows cross-sectional structures of fixed and movable electrode portions shown in FIG. 9.

FIG. 11 is a circuit diagram of a C/V conversion circuit applied to the third embodiment of the invention.

FIG. 12 shows a fourth embodiment in which the invention is applied to a triaxial (X-, Y-, and Z-directions) acceleration sensor.

FIG. 13 shows a fifth embodiment in which the invention is applied to a triaxial (X-, Y-, and Z-directions) acceleration sensor.

FIG. 14 shows a sixth embodiment in which the invention is applied to a triaxial (X-, Y-, and Z-directions) acceleration sensor.

### DESCRIPTION OF EXEMPLARY EMBODIMENTS

Hereinafter, preferred embodiments of the invention will be described in detail. The embodiments described below are not intended to unreasonably limit the content of the invention set forth in the claims. Also, not all of the configurations described in the embodiments are essential as solving means.

### 1. First Embodiment

In a first embodiment, the invention is applied to an acceleration sensor module for a Z-direction that is a vertical direction of a substrate, and a sensor chip and an IC chip are integrally formed by a wafer process.

### 1.1. MEMS Sensor

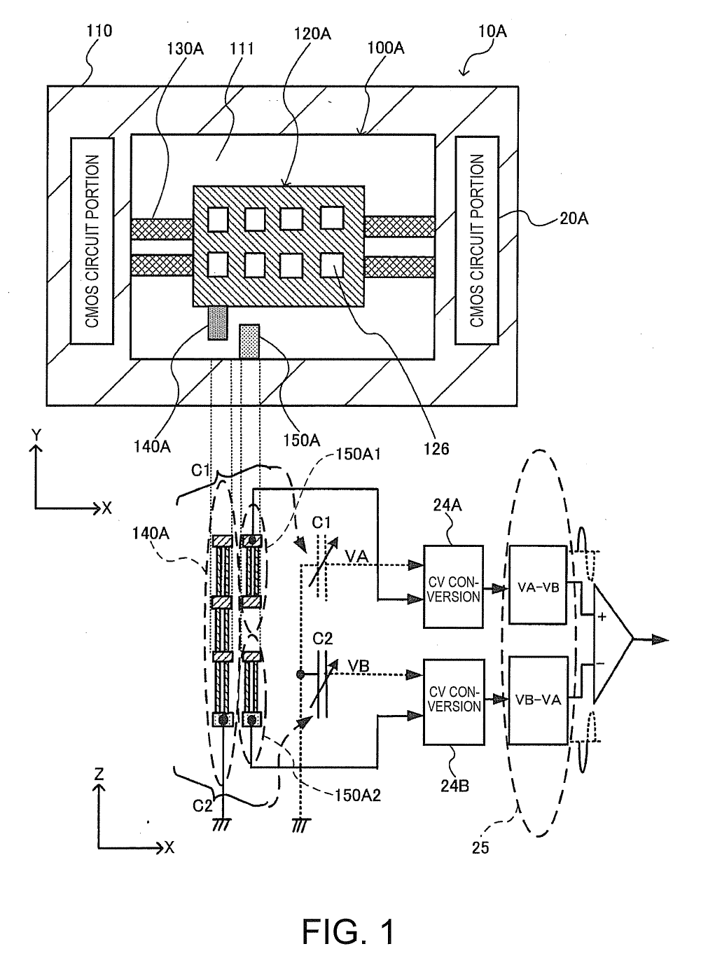

FIG. 1 is a schematic view of an acceleration sensor module 10A on which a MEMS portion 100A according to the first embodiment to which a MEMS sensor of the invention is applied is mounted. The MEMS portion 100A according to the first embodiment has, for example, a movable weight portion 120A including a movable electrode portion (first movable electrode portion) 140A, a supporting portion (also referred to as a fixed frame portion) 110 disposed around the movable weight portion 120A via a first gap portion 111, a fixed electrode portion (first fixed electrode portion) 150A having a facing-electrode face that faces a movable-electrode face of the movable electrode portion 140A via the first gap portion 111, and elastically deformable connecting portions 130A that support the movable weight portion 120A by coupling to the supporting portion 110 and can vary the facing area between the facing-electrode face and the movable-electrode face. In the embodiment, the moving direction of the movable weight portion 120A is a Z-direction orthogonal to a two-dimensional coordinate XY plane in FIG. 1.

### 1.2. Movable Weight Portion

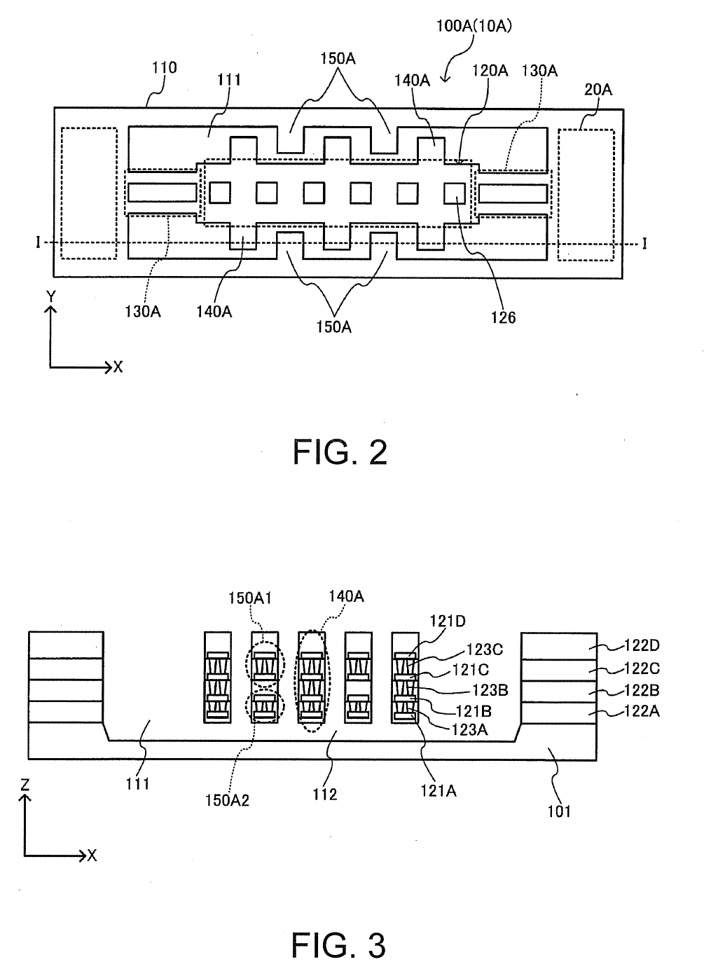

FIG. 2 is a schematic plan view of the acceleration sensor module 10A on which the MEMS portion 100A according to the first embodiment to which the MEMS sensor of the invention is applied is mounted. The shapes of the movable weight portion 120A, the movable electrode portions 140A, the fixed electrode portions 150A, and the like are different from those in FIG. 1, but the basic configuration is the same as that in FIG. 1. FIG. 3 is a cross-sectional view taken along line I-I of FIG. 2. On the acceleration sensor module 10A, integrated circuit portions (CMOS circuit portions) 20A are mounted together with the MEMS portion 100A. The MEMS portion 100A can be formed also by using manufacturing process steps of the integrated circuit portion (also referred to as a CMOS integrated circuit portion) 20A.

The MEMS portion 100A has the movable weight portion 120A movably supported by the connecting portions 130A in the Z-direction in the first gap portions 111 inside the fixed frame portion (supporting portion in the broad sense) 110. The movable weight portion 120A has a predetermined mass. For example, when acceleration acts on the movable weight portion 120A in the Z-direction in a state where the movable weight portion 120A is stopped, force in a direction opposite to the acceleration acts on the movable weight portion 120A to move the movable weight portion 120A.

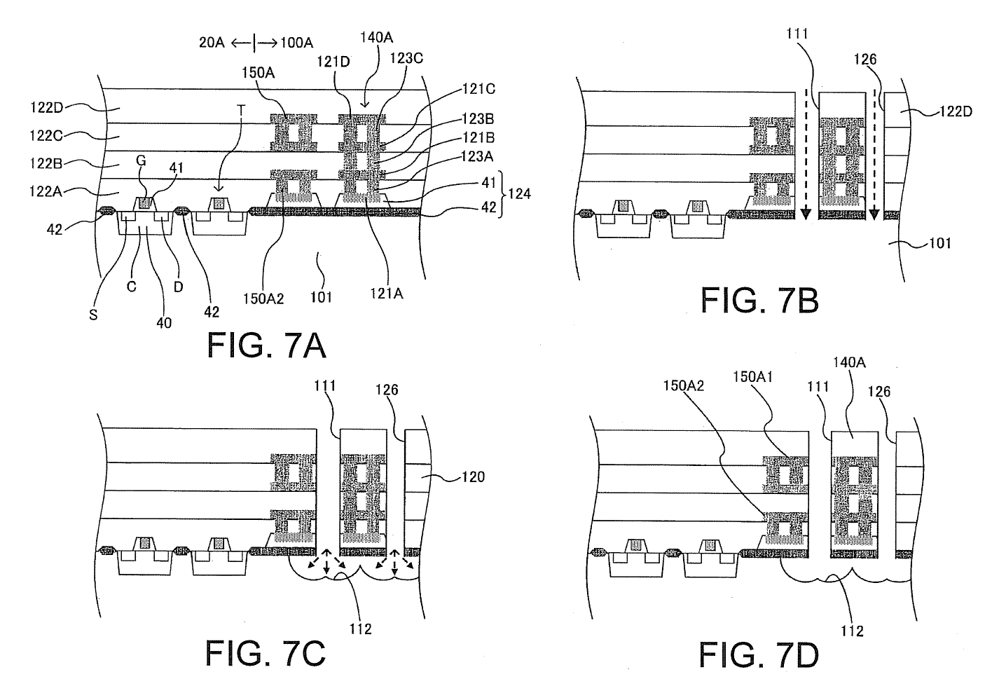

Before describing the structure of the movable weight portion 120A, the integrated circuit portion 20A will be described with reference to FIG. 7A. FIG. 7A shows a state where the manufacture of the CMOS integrated circuit portion 20A is completed but the MEMS portion 100A is in the process of manufacture. In FIG. 7A, impurity layers, for example, N-type wells 40 are formed on a substrate, for example, a P-type semiconductor substrate 101, and a source S, a drain D, and a channel C are formed in the well 40. Agate electrode G (also referred to as a conductive layer 121A) is formed above the channel C via a gate oxide film 41. In a field region (including the MEMS portion 100A) for device isolation, a thermal oxide film 42 is formed as a field oxide film. In this manner, transistors T are formed on the silicon substrate 101, and wiring is made for the transistors T, so that the CMOS integrated circuit portion 20A is completed. In FIG. 7A, with conductive layers 121B to 121D formed between inter-layer insulating layers 122A to 122C and plugs 123A to 123C, wiring is made for the source S, drain D, and gate G of the transistor T. A protective layer 122D is formed in the uppermost layer. The gate oxide film 41 and the thermal oxide film 42 in the MEMS portion 100A are also referred collectively to as an insulating film 124.

As shown in FIG. 3, the movable weight portion 120A can include the plurality of conductive layers 121A to 121D, the plurality of inter-layer insulating layers 122A to 122C respectively disposed between the plurality of conductive layers 121A to 121D, and the plugs 123A to 123C filled into embedding groove patterns that are respectively formed through the plurality of inter-layer insulating layers 122A to 122C. For the purpose of increasing the mass of the movable weight portion 120A, the insulating layer 124 may be present below the conductive layer 121A, or the protective layer 122D may be provided in the uppermost layer, in the movable electrode portion 140A.

The groove pattern formed through each of the plurality of inter-layer insulating layers 122A to 122C is a grid-like pattern, for example, and the plugs 123A to 123C are formed in a grid. For the material of the plugs 123A to 123C, a necessary condition is that the material is greater in specific gravity than the inter-layer insulating films 122A to 122C. When the plugs 123A to 123C are used also for electrical continuity, a conductive material is used.

In the embodiment, the conductive layer 121A in the lowermost layer above the substrate 101 is, for example, a polysilicon layer formed on the insulating film 124 on the silicon substrate 101 in the integrated circuit portion 20A in FIG. 7A. The other three conductive layers 121B to 121D are metal layers, for example, Al layers. The plugs 123A to 123C are metal, and formed of, for example, tungsten.

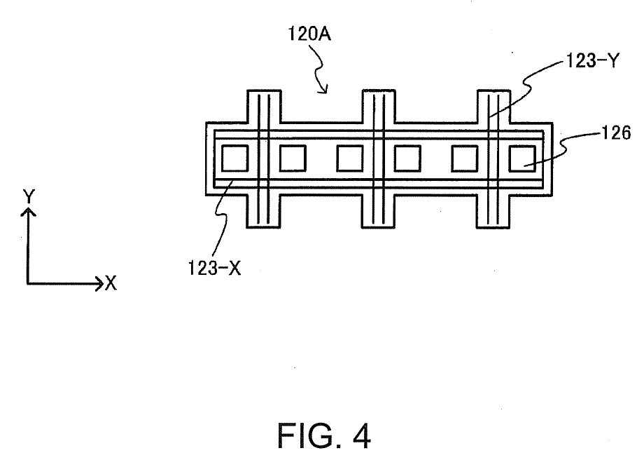

The plugs 123A to 123C formed in the layers of the movable weight portion 120A are continuously formed in the Z-direct ion in the drawing in the inter-layer insulating layers 122A to 122C. FIG. 4 shows a horizontal cross section of the movable weight portion 120A. In the embodiment, when orthogonal two axes of the two-dimensional plane are defined as an X-direction and a Y-direction, the plugs 123A to 123C formed in the layers are formed in a grid, including plugs 123-X extending in a wall shape along the X-direction and plugs 123-Y extending in a wall shape along the Y-direction.

As described above, the structure of the movable weight portion 120A of the embodiment includes the plurality of conductive layers 121A to 121D, the inter-layer insulating layers 122A to 122C, and the plugs 123A to 123C in the same manner as a typical IC cross-section. Therefore, the structure can be formed also by using the manufacturing steps of the integrated circuit portion 20A. In addition, the members formed also by using the manufacturing steps of the integrated circuit portion 20A are utilized for contributing to an increase in weight of the movable weight portion 120A.

Especially in the movable weight portion 120A formed also by using the IC manufacturing steps, the plugs 123A to 123C formed in the layers are devised so as to increase the mass of the movable weight portion 120A. As described above, since the plugs 123A to 123C formed in the layers include the two kinds of plug 123-X and plug 123-Y, the wall portions of the plug 123-X and the plug 123-Y can increase the weight.

In the embodiment, for further increasing the weight of the movable weight portion 120A, the protective layer 122D covering the conductive layer 121D in the uppermost layer is formed.

For making the movable weight portion 120A movable in the Z-direction perpendicular to the substrate 101, a space needs to be formed for the movable weight portion 120A on the lower side thereof, in addition to the gap portions 111 on the sides. Therefore, the silicon substrate 101 below the conductive layer 121A as the lowermost layer of the movable weight portion 120A or below the insulating layer 124 is removed by etching to form a second gap portion 112 (refer to FIG. 3).

The movable weight portion 120A can include one or plurality of through holes 126 that vertically penetrate therethrough in a region where the plugs 123A to 123C are not formed (refer to FIGS. 1 and 2). The through hole 126 is formed as a gas passage for forming the gap portion 112 by an etching process. Since the movable weight portion 120A is reduced in weight by the amount of the through holes 126 to be formed, the hole diameter and number of the through holes 126 are determined in such a range that an etching process can be carried out.

### 1.3. Connecting Portion

As described above, the connecting portions 130A are provided for movably supporting the movable weight portion 120A in a region where the first gap portions 111 and the second gap portion 112 are respectively formed on the sides of and below the movable weight portion 120A. The connecting portion 130A is intervened between the fixed frame portion 110 and the movable weight portion 120A.

The connecting portion 130A is elastically deformable so as to allow the movable weight portion 120A to move in a weight movable direction (Z-direction) in FIG. 3. In the same manner as the movable weight portion 120A, the connecting portion 130A is formed also by using the forming process of the integrated circuit portion 20A. In the embodiment, the connecting portion 130A provides spring properties as a cross-sectional structure having, for example, the conductive layer 121D in the uppermost layer in addition to the insulating layers 122A to 122D (that is, the conductive layers 121A to 121C and the plugs 123A to 123C are not present).

### 1.4. Movable Electrode Portion and Fixed Electrode Portion

The embodiment is directed to the electrostatic capacitive acceleration sensor, which has the movable electrode portions 140A and the fixed electrode portions 150A (150A1 and 150A2) whose areas between facing electrodes are changed by the action of acceleration as shown in FIGS. 1 to 3. The movable electrode portion 140A is integrated with the movable weight portion 120A and formed so as to protrude from the movable weight portion 120A. The fixed electrode portion 150A is integrated with the substrate 101 supporting the fixed frame portion 110.

In the same manner as the movable weight portion 120A, the fixed electrode portion 150A is formed also by using the forming process of the integrated circuit portion 20A.

In the embodiment as shown in FIGS. 1 and 3, two fixed electrode portions 150A are provided in the Z-direction. These are referred to as a first electrode portion 150A1 and a second electrode portion 150A2. As shown in FIG. 3, the first electrode portion 150A1 and the second electrode portion 150A2 are insulated from each other by the inter-layer insulating layer 122B. In the embodiment, the plug 123B is not formed in the inter-layer insulating layer 122B, whereby the first electrode portion 150A1 and the second electrode portion 150A2 are insulated from each other by the inter-layer insulating layer 122B. From another standpoint, it can be said that the movable electrode portion 140A and the fixed electrode portion 150A have a facing region where the plugs face each other and a non-facing region where the plugs do not face each other.

In the first embodiment, the first and second electrode portions 150A1 and 150A2 are provided for one movable electrode portion 140A, and the movable weight portion 120A including the movable electrode portion 140A can be set to a reference potential (for example, a ground potential). Conversely, first and second electrode portions may be provided in the movable electrode portion for one fixed electrode portion. In this case, the movable weight portion 120A needs to be separated for insulation into a current-carrying path of the first electrode portion and a current-carrying path of the second electrode portion.

### 1.5. Detecting Principle of Acceleration Sensor

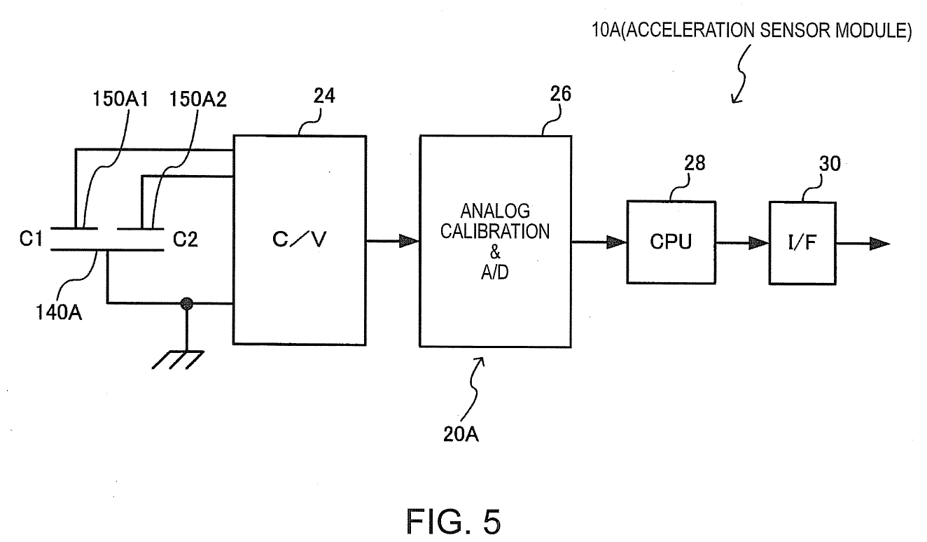

FIG. 5 is a block diagram of the acceleration sensor module 10A of the embodiment. In the MEMS portion 100A, the movable electrode portion 140A and the fixed electrode portion 150A constitute a variable capacitor C. The potential of one electrode (for example, the movable electrode portion) of the capacitor C is a reference potential (for example, a ground potential).

The integrated circuit portion 20A includes, for example, a C/V conversion circuit 24, an analog calibration and A/D conversion circuit unit 26, a central processing unit (CPU) 28, and an interface (I/F) circuit 30. However, this configuration is an example and is not restrictive. For example, the CPU 28 can be replaced by control logic, and the A/D conversion circuit can be disposed in the output stage of the C/V conversion circuit 24.

When acceleration acts on the movable weight portion 120A in a state where the movable weight portion 120A is stopped, force in a direction opposite to the acceleration acts on the movable weight portion 120A to change facing electrode areas of the movable and fixed electrode pair. For example, when it is assumed that the movable weight portion 120A is moved toward the upward direction in FIG. 3, the facing electrode area between the movable electrode portion 140A and the first electrode portion 150A1 does not change, but the facing electrode area between the movable electrode portion 140A and the second electrode portion 150A2 decreases. Since the facing electrode area and the capacitance are in a proportional relation, the capacitance value of a capacitor C2 formed of the movable electrode portion 140A and the second electrode portion 150A2 decreases. Conversely, when the movable weight portion 120A is moved toward the downward direction in FIG. 3, the facing electrode area between the movable electrode portion 140A and the second electrode portion 150A2 does not change, but the facing electrode area between the movable electrode portion 140A and the first electrode portion 150A1 decreases. Thus, the capacitance of a capacitor C1 decreases. As described above, when two fixed electrode portions 150A1 and 150A2 are provided for one movable electrode portion 140A, also the direction of acceleration can be detected depending on which of the fixed electrode portions changes in capacitance. It is apparent that a physical quantity can be detected by providing one fixed electrode portion for one movable electrode portion under the specification in which only one of upward direction and downward direction of the Z-direction is detected.

When the capacitance values of the capacitors C1 and C2 change as described above, the movement of charge occurs in accordance with Q=CV. The C/V conversion circuit 24 has a charge amplifier using, for example, a switched capacitor. The charge amplifier converts a minute current signal caused by the movement of charge into a voltage signal by sampling operation and integration (amplification) operation. A voltage signal (that is, a physical quantity signal detected by the physical quantity sensor) output from the C/V conversion circuit 24 is subjected to calibration processing (for example, adjustment of phase or signal amplitude, and low-pass filter processing may be further performed) by the analog calibration and A/D conversion circuit unit 26, and thereafter converted from an analog signal to a digital signal.

As shown in FIG. 1, it is possible to respectively connect C/V conversion circuits 24A and 24B to the capacitance C1 and the capacitance C2 and to provide a differential signal generating portion 25 in the later stage of the C/V conversion circuits 24A and 24B. When voltages corresponding to the capacitances C1 and C2 are respectively defined as VA and VB, the differential signal generating portion 25 generates differential signals based on respective calculations of VA−VB and VB−VA. Both the thus obtained differential signals VA−VB and VB−VA change when the movable electrode portion 140A is displaced. Further in FIG. 1, the differential signals are differentially amplified, whereby voltages corresponding to the magnitude and direction of acceleration are generated.

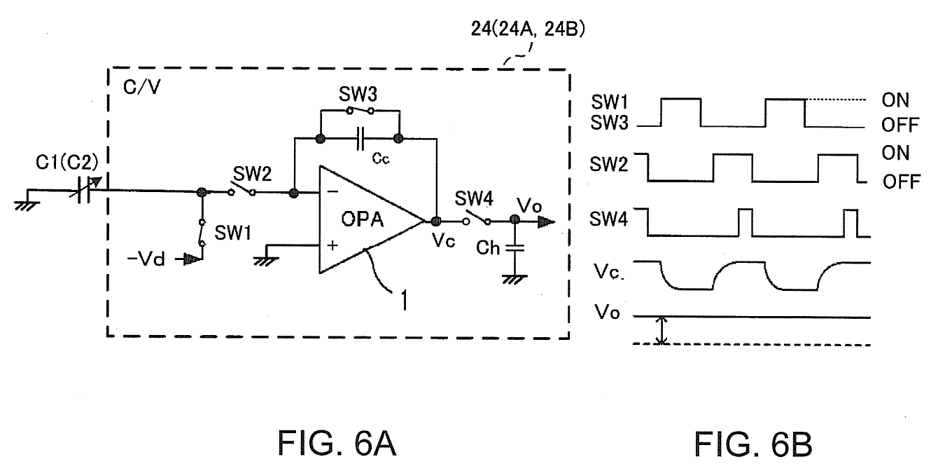

By using FIGS. 6A and 6B, the configuration and operation of the C/V conversion circuit 24 (also including the C/V conversion circuits 24A and 24B) will be described. FIG. 6A shows the basic configuration of a charge amplifier using a switched capacitor. FIG. 6B shows voltage waveforms of respective parts of the charge amplifier shown in FIG. 6A.

As shown in FIG. 6A, the C/V conversion circuit has a first switch SW1 and a second switch SW2 (constituting a switched capacitor of an input part together with the variable capacitance C), an operational amplifier OPA1, a feedback capacitance (integral capacitance) Cc, a third switch SW3 for resetting the feedback capacitance Cc, a fourth switch SW4 for sampling an output voltage Vc of the operational amplifier OPA1, and a holding capacitance Ch.

As shown in FIG. 6B, the on/off of the first switch SW1 and the third switch SW3 is controlled by a first clock of the same phase, and the on/off of the second switch SW2 is controlled by a second clock having an opposite phase from the first clock. The fourth switch SW4 is briefly turned on at the end of a period in which the second switch SW2 is turned on. When the first switch SW1 is turned on, a predetermined voltage Vd is applied to both ends of the variable capacitance C, so that charge is accumulated in the variable capacitance C. In this case, the feedback capacitance Cc is in a reset state (state of being short-circuited between both ends) because the third switch is in the on state. Next, the first switch SW1 and the third switch SW3 are turned off, and the second switch SW2 is turned on, the both ends of the variable capacitance C are at a ground potential. Therefore, the charge accumulated in the variable capacitance C moves toward the operational amplifier OPA1. In this case, since the charge amount is stored, a relation of Vd·C=Vc·Cc is established. Accordingly, the output voltage Vc of the operational amplifier OPA1 is expressed by (C/Cc)·Vd. That is, the gain of the charge amplifier is determined by the ratio between the capacitance value of the variable capacitance C and the capacitance value of the feedback capacitance Cc. Next, when the fourth switch (sampling switch) SW4 is turned on, the output voltage Vc of the operational amplifier OPA1 is held by the holding capacitance Ch. Vo denotes the held voltage. The voltage V0 serves as the output voltage of the charge amplifier.

The above-described configuration of the C/V conversion circuit is an example, and the C/V conversion circuit is not restricted to the configuration. For the convenience of description, only one movable and fixed electrode pair is shown in FIG. 1. However, this is not restrictive. The number of electrode pairs can be increased in accordance with a required capacitance value as shown in FIG. 2.

### 1.6. Manufacturing Method

A method of manufacturing the acceleration sensor module 10A shown in FIG. 1 will be schematically described with reference to FIGS. 7A to 7D.

### 1.6.1. Forming Step of Conductive Layers, Plugs, and Insulating Layers

FIG. 7A shows a state where the CMOS integrated circuit portion 20A is completed, but the MEMS portion 100A is not completed. The CMOS integrated circuit portion 20A shown in FIG. 7A is manufactured by a publicly-known process.

In FIG. 7A, the surface of a substrate, for example, the P-type silicon semiconductor substrate 101 is first oxidized, and thereafter a field region is thermally oxidized using, as a mask, a nitride film or the like that is patterned by a photolithography step to form the LOCOS 42. Next, the N-type wells (impurity layers) 40, for example, having a different polarity from the substrate 101 are formed. Next, the entire surface of the substrate 101 is thermally oxidized to form the insulating layer (for example, an SiO₂ film) 41 serving as a gate oxide film. Further, the material of a first conductive layer, for example, polysilicon is deposited on the insulating layer 41 and etched by using a resist film that is patterned by a photolithography step to form the first conductive layer 121A. The formation of the first conductive layer 121A is carried out simultaneously with a forming step of the gate electrode G. In the embodiment, a polysilicon layer (Poly-Si) is formed to a thickness of from 100 to 5000 angstrom by CVD (Chemical Vapor Deposition) and pattern etched by a photolithography step to form the first conductive layer 121A. The first conductive layer 121A can be formed of silicide or a high-melting-point metal in addition to polysilicon.

Next, the source S and the drain D are formed in the well 40 by impurity implantation, and the channel C is formed between the source S and the drain D. In this manner, N-type and P-type transistors T are formed in the integrated circuit portion 20A. Next, wiring is made for the transistors T, and by using the wiring layer, a wiring layer is formed also in the MEMS portion 100A.

First, an oxide film is deposited on the entire surface, and thereafter the inter-layer insulating layer 122A having contact holes formed by using a resist film that is patterned by a photolithography step is formed. The first-layer plug 123A is formed in the contact holes of the inter-layer insulating layer 122A. Further, the second conductive layer (first metal layer in the embodiment) 121B connected to the plug 123A is formed on the inter-layer insulating layer 122A.

In the embodiment, a material such as, for example, NSG, BPSG, SOG, or TEOS is formed to a thickness of from 10000 to 20000 angstrom by CVD to form the first inter-layer insulating layer 122A. Thereafter, the first inter-layer insulating layer 122A is pattern etched by a photolithography step to form an embedding groove pattern in which the first plug 123A is embedded to be formed. A material such as W, TiW, or TiN is embedded in the embedding groove pattern by sputtering, CVD, or the like. Thereafter, the conductive layer material on the first inter-layer insulating layer 122A is removed by etching back or the like to complete the first plug 123A. The first plug 123A may be flattened by performing a CMP (Chemical Mechanical Polishing) step. The plug 123A may be formed by sequentially sputtering, for example, barrier plating, a high-melting-point metal, for example, tungsten, and a cap metal. This enables the connection to the gate G, source S, and drain D of the transistor T.

The second conductive layer 121B can be formed as a plural-layer structure in which Ti, TiN, TiW, TaN, WN, VN, ZrN, NbN, or the like is used as a barrier layer, Al, Cu, an Al alloy, Mo, Ti, Pt, or the like is used as a metal layer, and TiN, Ti, amorphous Si, or the like is used as an antireflection layer. The same materials as the second conductive layer 121B can be used also for forming the third and fourth conductive layers 121C and 121D. The barrier layer can be formed to a thickness of from 100 to 1000 angstrom by sputtering. The metal layer can be formed to a thickness of from 5000 to 10000 angstrom by sputtering, vacuum deposition, or CVD. The antireflection layer can be formed to a thickness of from 100 to 1000 angstrom by sputtering or CVD.

Next, the second inter-layer insulating layer 122B, the second plug 123B, and the third conductive layer 121C are formed. The second inter-layer insulating layer 122B is formed in the same manner as the first inter-layer insulating layer 122A. Thereafter, the second inter-layer insulating layer 122B is pattern etched by a photolithography step to form an embedding groove pattern in which the second plug 123B is embedded to be formed. The same material as the first plug 123A is embedded in the embedding groove pattern by sputtering, CVD, or the like. Thereafter, the conductive layer material on the second inter-layer insulating layer 122B is removed by etching back or the like to complete the second plug 123B. Planarization may be carried out by performing the CMP (Chemical Mechanical Polishing) step. Thereafter, the third conductive layer 121C is formed. The formation of the third conductive layer 121C is carried out simultaneously with a forming step of a second metal wiring layer in the integrated circuit portion 20A. The forming pattern of the third conductive layer 121C is substantially the same as that of the second conductive layer 121B in a region corresponding to the movable weight portion 120A.

Next, the third inter-layer insulating layer 122C, the third plug 123C, the fourth conductive layer 121D, and the protective layer 122D are formed. The third inter-layer insulating layer 122C is formed in the same manner as the first and second inter-layer insulating layers 122A and 122B. Thereafter, the third inter-layer insulating layer 122C is pattern etched by a photolithography step to form an embedding groove pattern in which the third plug 123C is embedded to be formed. The same material as the first and second plugs 123A and 123B is embedded in the embedding groove pattern by sputtering, CVD, or the like. Thereafter, the conductive layer material on the third inter-layer insulating layer 122C is removed by etching back or the like to complete the third plug 123C. Planarization may be carried out by performing a CMP (Chemical Mechanical Polishing) step. The plane pattern of the third plug 123C is substantially the same as that of the second plug 123B.

The formation of the fourth conductive layer 121D is carried out simultaneously with a forming step of a third metal wiring layer in the integrated circuit portion 20A. The forming pattern of the fourth conductive layer 121D is substantially the same as that of the second and third conductive layers 121B and 121C in the region corresponding to the movable weight portion 120A. In the embodiment, the fourth conductive layer 121D is drawn from a region corresponding to the connecting portion 130A over a region corresponding to the fixed frame portion 110 as shown in FIG. 3, so that the fourth conductive layer 121D can be utilized as a wiring pattern for making the wiring connection to the integrated circuit portion 20A side. This causes the movable electrode portion 140A to be connected to the integrated circuit portion 20A via the conductive layers of the movable weight portion 120A and the connecting portion 130A. In this manner, when the MEMS monolithic configuration is achieved, connection by wire bonding is not required, but the shortest connection can be made by routing the wiring layer. Therefore, the wiring distance can be shortened to reduce the wiring capacitance, and sensing accuracy (noise resistance) can be improved. The protective layer 122D is formed by depositing, for example, PSiN, SiN, SiO₂, or the like to a thickness of from 5000 to 20000 angstrom by CVD.

In this manner, by using a part or entire of the plurality of conductive layers 121A to 121D, the plurality of inter-layer insulating layers 122A to 122C, the plurality of plugs 123A to 123C, the insulating layer 124, and the protective layer 122D, necessary for forming the CMOS integrated circuit portion 20A, the MEMS portion 100A can be formed. Here, the insulating layer 124 below the conductive layer (for example, a polysilicon layer, etc.) 121A in the lowermost layer corresponds to the gate oxide film 41 and thermal oxide film 42.

At the stage shown in FIG. 7A, the movable electrode portion 140A is formed from the first to fourth conductive layers 121A to 121D and the plugs 123A to 123C in the layers for connecting between the respective first to fourth conductive layers. The first fixed electrode portion 150A1 is formed from the third and fourth conductive layers 121C and 121D and the plug 123C. The second fixed electrode portion 150A2 is formed from the first and second conductive layers 121A and 121B and the plug 123A. The plug 123B is not formed in the inter-layer insulating layer 122B that electrically insulates the first and second fixed electrode portions 150A1 and 150A2 from each other.

### 1.6.2. Anisotropic Etching Step

FIG. 7B shows a forming step of the first gap portion 111 and the through hole 126. In the step of FIG. 7B, holes (the first gap portion 111 and the through hole 126) reaching from the surface of the protective layer 122D to the surface of the silicon substrate 101 are formed. Therefore, the inter-layer insulating layers 122A to 122C, the insulating layer 124, and the protective layer 122D are etched. The etching step is insulating film anisotropic etching in which the ratio (H/D) of an etching depth (for example, 4 to 6 μm) to an opening diameter D (for example, 1 μm) is a high aspect ratio. With this etching, the fixed frame portion 110, the movable weight portion 120A, and the connecting portions 130A can be separated from one another.

The anisotropic etching is preferably performed by using the conditions for etching a typical inter-layer insulating film between wiring layers of a CMOS. The processing can be carried out by performing dry etching using, for example, a mixed gas of CF₄, CHF₃, and the like.

### 1.6.3. Isotropic Etching Step

FIG. 7C shows a silicon isotropic etching step for forming the second gap portion 112. FIG. 7D shows the MEMS portion 100A that is completed through the etching step of FIG. 7C. The etching step shown in FIG. 7C uses as openings the first gap portion 111 and the through hole 126 formed in the etching step shown in FIG. 7B to etch the silicon substrate 101 situated below the movable weight portion 120A, the connecting portions 130A, the movable electrode portion 140A, and the fixed electrode portion 150A (150A1 and 150A2), thereby forming the second gap portion 112. As the silicon etching method, there is a method in which an etching gas XeF₂ is introduced to a wafer disposed in an etching chamber. The etching gas needs not to be plasma excited, and gas etching is possible. As described in JP-A-2002-113700, for example, an etching process at a pressure of 5 kPa can be performed with XeF₂. Moreover, XeF₂ has a vapor pressure of about 4 Torr, and etching is possible at or below the vapor pressure. Also an etching rate of 3 to 4 μm/min can be expected. In addition, ICP etching can be used. For example, when a mixed gas of SF₆ and O₂ is used, a pressure in the chamber is set to 1 to 100 Pa, and a RF power of about 100 W is supplied, etching of 2 to 3 μm is completed in several minutes.

### 2. Second Embodiment

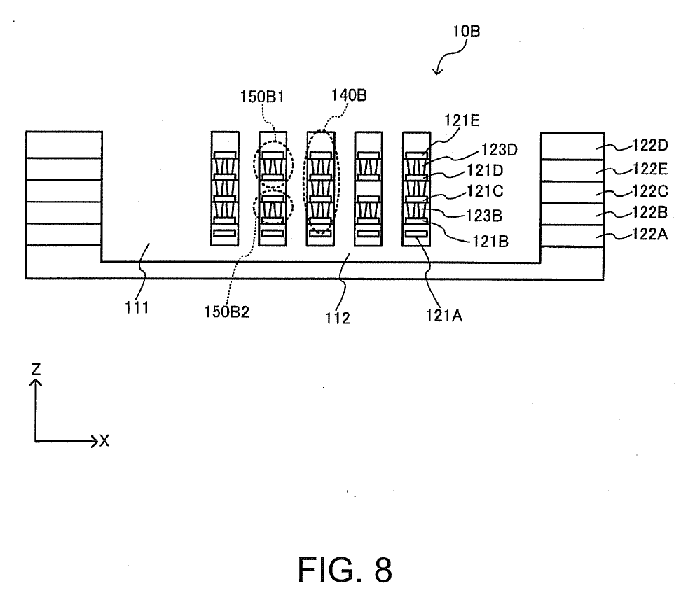

FIG. 8 is a cross-sectional view showing a second embodiment of the invention, showing a cross-sectional structure different from that in FIG. 3 of the first embodiment. In FIG. 3, the first electrode portion 150A1 includes the conductive layers 121C and 121D and the plug 123C connecting between the conductive layers, and the second electrode portion 150A2 includes the conductive layers 121A and 121B and the plug 123A connecting between the conductive layers. The conductive layer 121A is a polysilicon layer, which is different in material from the other conductive layers 121B to 121D and has a different thickness. Therefore, when the conductive layer 121A is included to the second electrode portion 150A2 side, the difference in length in the Z-direction is likely to be generated between the first and second electrode portions 150A1 and 150A2 even if the number of conductive layers is made equal therebetween.

In the second embodiment, the first conductive layer 121A as a polysilicon layer does not function as fixed electrode portions 150B1 and 150B2. That is, in FIG. 8, the first electrode portion 150B1 includes the conductive layer 121D and a conductive layer 121E and a plug 123D connecting between the conductive layers, and the second electrode portion 150B2 includes the conductive layers 121B and 121C and the plug 123B connecting between the conductive layers. With this configuration, although the fifth conductive layer 121E, the fourth plug 123D, and an inter-layer insulating layer 122E are added, the lengths of the first and second electrode portions 150B1 and 150B2 in the Z-direction can be easily made equal to each other. Also in the second embodiment, the first and second movable electrode portions may be provided for one fixed electrode portion.

### 3. Third Embodiment

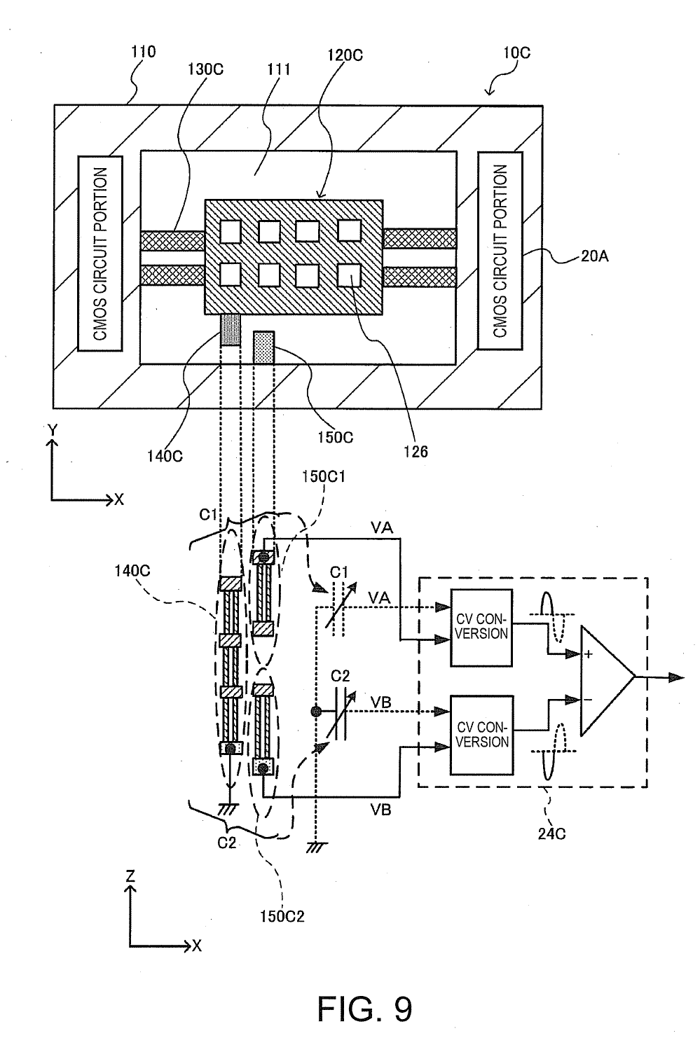

FIG. 9 shows a third embodiment of the invention. In FIG. 9, members having the same function as those in FIG. 1 are denoted by the same reference numerals and signs. A movable weight portion 120C, connecting portions 130C, a movable electrode portion 140C, and a fixed electrode portion 150C of a module 10C each have a cross-sectional structure different from that in FIG. 1. As a result of having the different cross-sectional structure, an upper end of the movable electrode portion 140C is situated lower than an upper end of a first electrode portion 150C1, and a lower end of the movable electrode portion 140C is situated higher than a lower end of a second electrode portion 150C2.

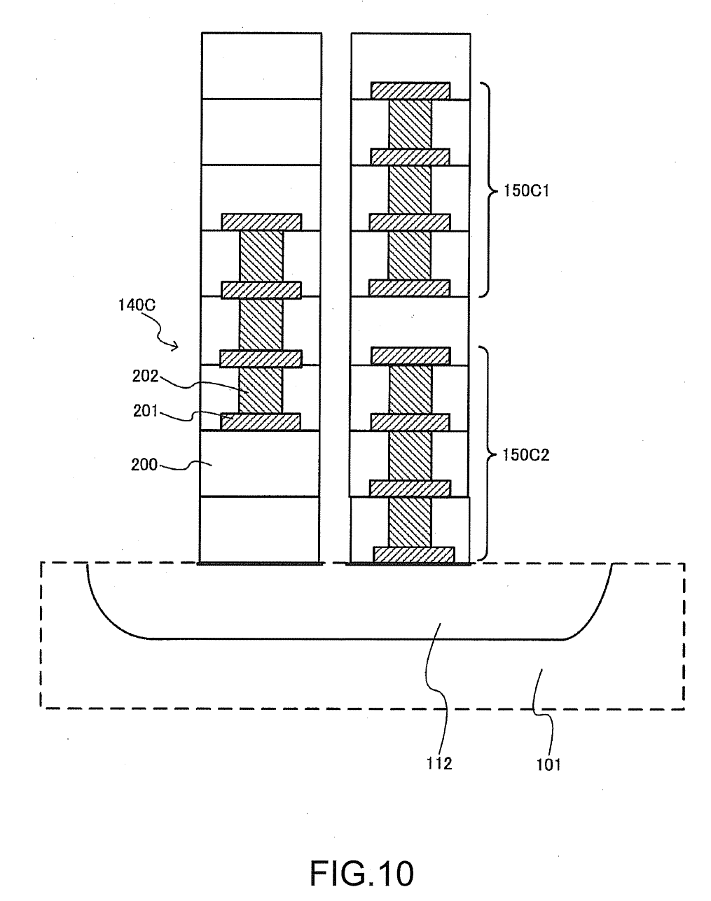

The movable electrode portion 140C, the first electrode portion 150C1, and the second electrode portion 150C2 described above can be realized by selectively providing a conductive layer 201 formed on an insulating layer 200 in each of layers and/or a plug 202 formed in the insulating layer 200 as shown in FIG. 10. However, it is preferable to form the conductive layer and the plug in all the layers for the movable weight portion to thereby increase the mass of the movable weight portion. As described above, the movable weight portion, the movable electrode portion, and the fixed electrode portion may not necessarily have the same cross-sectional structure. It is enough that they use a part or entire of the structure of the stacked structure forming the movable weight portion.

Different from FIG. 1, the capacitances C1 and C2 change in a complementary manner when the movable electrode portion 140C is displaced in FIG. 9. That is, when it is assumed that the movable electrode portion 140C moves upwardly in the Z-direction in FIG. 9, while the facing electrode area between the movable electrode portion 140C and the first electrode portion 150C1 decreases, the facing electrode area between the movable electrode portion 140C and the second electrode portion 150C2 increases. Accordingly, whereas the capacitance C1 decreases, the capacitance C2 increases. Conversely, when the movable electrode portion 140C moves downwardly in the Z-direction in FIG. 9, while the facing electrode area between the movable electrode portion 140C and the first electrode portion 150C1 increases, the facing electrode area between the movable electrode portion 140C and the second electrode portion 150C2 decreases. Accordingly, whereas the capacitance C1 increases, the capacitance C2 decreases.

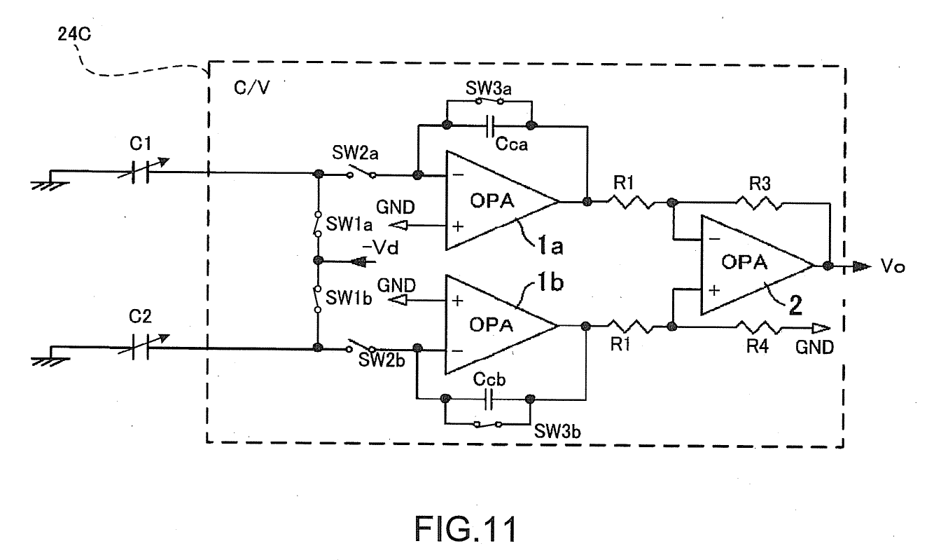

In this case, the differential signal generating portion 25 in FIG. 1 is unnecessary. The C/V conversion circuit 24 in FIG. 9 can use a differential charge amplifier as shown in FIG. 11. In the charge amplifier shown in FIG. 11, in the input stage, a first switched-capacitor amplifier (SW1a, SW2a, OPA1a, Cca, and SW3a) for amplifying a signal from the variable capacitance C1 and a second switched-capacitor amplifier (SW1b, SW2b, OPA1b, Ccb, and SW3b) for amplifying a signal from the variable capacitance C2 are provided. Respective output signals (differential signals) of the operational amplifiers OPA1a and OPA1b are input to a differential amplifier (OPA2 and resistances R1 to R4) provided in the output stage. As a result, the output signal Vo amplified is output from the operational amplifier OPA2. The use of the differential amplifier provides an effect that base noise can be removed.

### 4. Fourth Embodiment

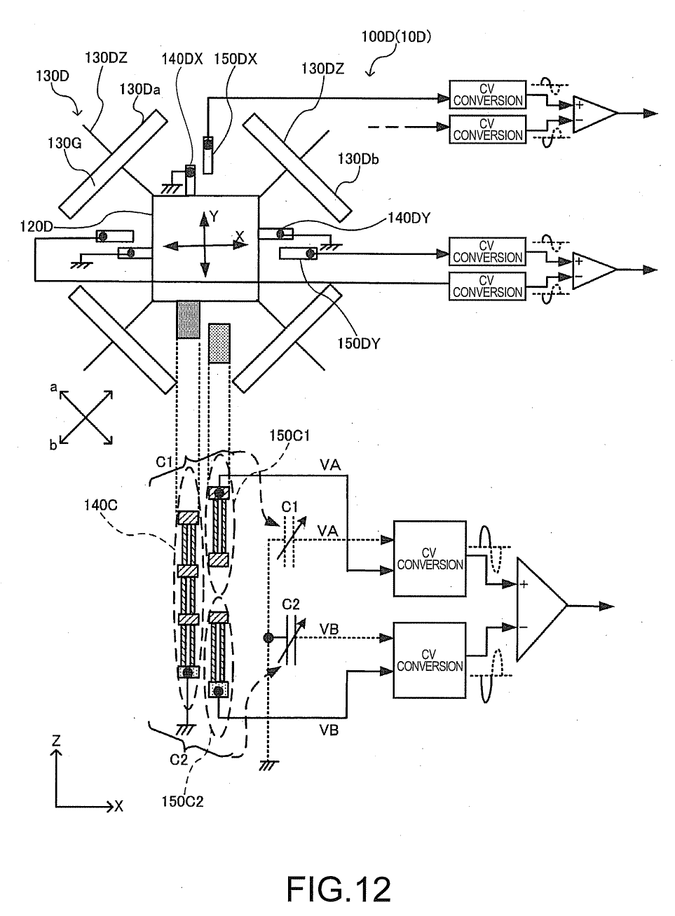

Next, a fourth embodiment of the invention will be described with reference to FIG. 12. In the following description, only the differences between the third embodiment and the fourth embodiment will be described. An acceleration sensor module 10D according to the fourth embodiment is a triaxial (X-, Y-, and Z-directions) acceleration sensor module to which the invention is applied. In the same manner as the first embodiment, a sensor chip and an IC chip can be integrally formed by a wafer process. In the fourth embodiment, the acceleration sensor 100D has a movable weight portion 120D.

The movable weight portion 120D is supported by a connecting portion 130D so as to be elastically deformable in, in addition to the Z-direction orthogonal to the two-dimensional plane parallel to the substrate, at least one direction of orthogonal two axes X and Y on the two-dimensional plane. In the embodiment, the connecting portion 130D has four Z-direction elastic deformable portions 130DZ along first and second diagonal line directions a and b on a plane of the movable weight portion 120D. The Z-direction elastic deformable portion 130DZ elastically deforms only in the Z-direction. In the middle of each of the two Z-direction elastic deformable portions 130DZ along the diagonal line direction a, a ring-shaped a-direction elastic deformable portion 130Da having a hollow portion 130G is provided. In the middle of each of the two Z-direction elastic deformable portions 130DZ along the diagonal line direction b, a ring-shaped b-direction elastic deformable portion 130Db similarly having a hollow portion 130G is provided. These a- and b-direction elastic deformable portions 130Da and 130Db deform in the a-direction and the b-direction due to change of the contour shape of the hollow portion 130G, so that the movable weight portion 120D can be moved in the X- and Y-directions.

The movable weight portion 120D has a second movable electrode portion 140DX protruding in the Y-direction and a second movable electrode portion 140DY protruding in the X-direction. The supporting portion 110 (not illustrated in FIG. 12) has second fixed electrode portions 150DX and 150DY facing the second movable electrode portions 140DX and 140DY. In the movable weight portion 120D, the movable electrode portion 140C that is formed in the same manner as in the third embodiment is disposed so as to face the first and second electrode portions 150C1 and 150C2 of the third embodiment.

When the movable weight portion 120D moves in the X-direction, the facing distance between the second fixed electrode 150DX and the second movable electrode 140DX is changed to change a capacitance. When the movable weight portion 120D moves in the Y-direction, the facing distance between one pair of the second fixed electrode 150DY and the second movable electrode 140DY increases, and the facing distance between the other pair of the second fixed electrode 150DY and the second movable electrode 140DY disposed so as to face them decreases, so that the difference in capacitance is generated therebetween. The capacitance is inversely proportional to the distance between electrodes. Since the capacitance changes in accordance with a change in the distance between electrodes, acceleration in the X- and Y-directions can be detected in the same manner as the movable electrode portion 140C and the fixed electrode portions 150C1 and 150C2 having sensitivity in the Z-direction.

In FIG. 12, since a fixed electrode portion (first fixed electrode portion) 150DZ, and the second fixed electrode portions 150DX and 150DY have the same potential (ground potential), the movable weight portion 120D can output three potentials corresponding to X, Y, and Z to the respective C/V converters 24. Conversely, the movable weight portion 120D may be set to a fixed potential to detect the three potentials corresponding to X, Y, and Z from the first and second electrode portions 150C1 and 150C2 formed in the fixed electrode portion and the second fixed electrode portions 150DX and 150DY. In the drawing, although only one pair of the second fixed electrode portion 140DX and the second movable electrode portion 150DX is formed, one more electrode pair may be formed on the facing side. The movable weight portion has a rectangular parallelepiped shape having first and second faces whose normal lines are in the Z-direction and first to fourth side faces connecting to the first and second faces. In FIG. 12, although at least each of the electrode pairs including the second fixed electrode and the second movable electrode as one pair is formed on both the first side face and the second side face facing the first side face, two electrode pairs may be formed side by side on the first side face.

In the fourth embodiment, the Z-direction detection can be implemented by using any of the first to third embodiments.

### 5. Fifth Embodiment

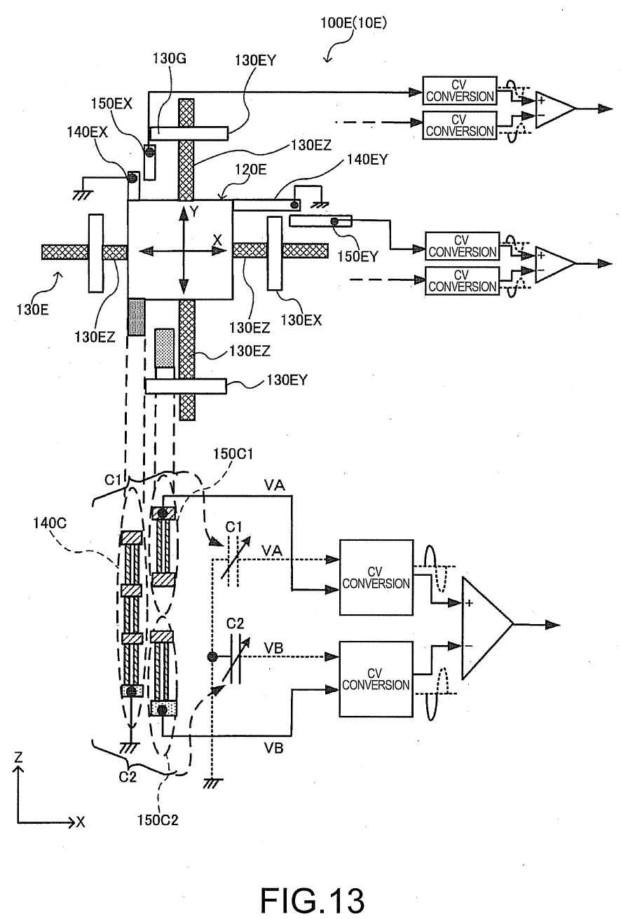

FIG. 13 shows an acceleration sensor 100E having a connecting portion different from that in FIG. 12. The connecting portion supporting a movable weight portion 120E of the acceleration sensor 100E has four Z-direction elastic deformable portions 130EZ along X and Y. In the middle of each of the two Z-direction elastic deformable portions 130EZ along the X-direction, a ring-shaped X-direction elastic deformable portion 130EX having the hollow portion 130G is provided. In the middle of each of the two Z-direction elastic deformable portions 130EZ along the Y-direction, a ring-shaped Y-direction elastic deformable portion 130EY similarly having the hollow portion 130G is provided. Also in this case, acceleration in the X-, Y-, and Z-directions can be detected in the same manner as in FIG. 12.

### 6. Sixth Embodiment

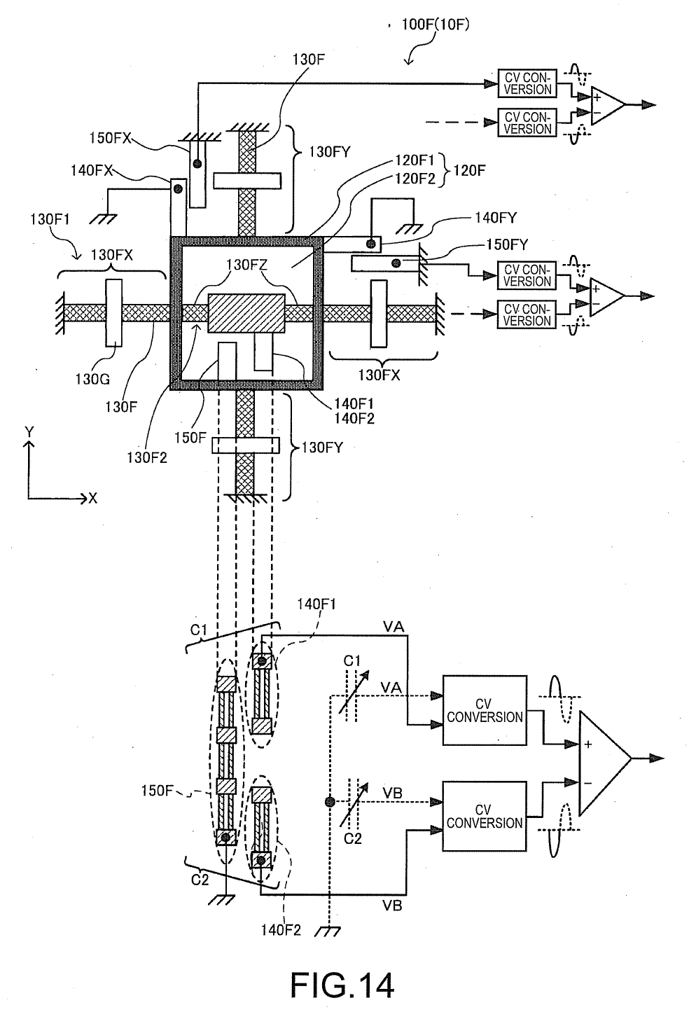

FIG. 14 shows an acceleration sensor 100F having a movable weight portion 120F. The movable weight portion 120F is divided into an outer first movable weight portion 120F1 and an inner second movable weight portion 120F2. The first movable weight portion 120F1 can move in, for example, the X- and Y-directions via a first connecting portion 130F1 relative to the supporting portion 110 (not illustrated in FIG. 14). The second movable weight portion 120F2 can move in, for example, the Z-direction via a second connecting portion 130F2 relative to the first movable weight portion 120F1. Conversely, the outer first movable weight portion 120F1 may move in the Z-direction, and the inner second movable weight portion 120F2 may move in the X- and Y-directions.

The first connecting portion 130F1 has two rigid bodies 130F along each of the X- and Y-directions, that is, four rigid bodies in total. An X-direction elastic deformable portion 130FX has the hollow portion 130G in the middle of each of the two rigid bodies 130F along the X-direction. A Y-direction elastic deformable portion 130FY has the hollow portion 130G in the middle of each of the two rigid bodies 130F along the Y-direction. The second connecting portion 130F2 is formed of, for example, two Z-direction elastic deformable portions 130FZ that are elastically deformable only in the Z-direction.

The first movable weight portion 120F1 has a first protruding movable electrode portion 140FX protruding in the Y-direction and a second protruding movable electrode portion 140FY protruding in the X-direction. The supporting portion 110 (not illustrated in FIG. 14) has first and second protruding fixed electrode portions 150FX and 150FY facing the first and second protruding movable electrode portions 140FX and 140FY. First and second movable electrode portions 140F1 and 140F2 provided for the second movable weight portion 120F2 are disposed so as to face the fixed electrode portion 150F provided for the first movable weight portion 120F1. Conversely, first and second electrode portions provided for the first movable weight portion 120F1 may be disposed so as to face the movable electrode portion provided for the second movable weight portion 120F2. Also in this case, acceleration in the X-, Y-, and Z-directions can be detected in the same manner as in FIGS. 12 and 13.

In FIGS. 12 to 14, the pair of fixed electrode portion and movable electrode portion in the X- and Y-directions can be provided in plural numbers.

### 7. Modified Examples

Although the embodiments have been described above in detail, those skilled in the art should readily understand that many modifications may be made without substantially departing from the novel matter and effects of the invention. Accordingly, those modified examples are also included in the scope of the invention. For example, a term described at least once with a different term with a broader sense or the same meaning in the specification or the accompanying drawings can be replaced with the different term in any part of the specification or the accompanying drawings.

For example, the MEMS sensor according to the invention is not necessarily applied to an electrostatic capacitive acceleration sensor but can be applied to a piezo-resistive acceleration sensor. Moreover, the MEMS sensor is applicable as long as the sensor is a physical sensor that detects change in capacitance based on the movement of a movable weight portion. For example, the MEMS sensor can be applied to a gyro sensor, a pressure sensor, or the like. Moreover, the MEMS sensor according to the invention can be applied to electronic apparatuses such as digital cameras, car navigation systems, mobile phones, mobile PCs, and game controllers in addition to the embodiments. The use of the MEMS sensor according to the invention can provide an electronic apparatus having excellent detection sensitivity especially in the Z-direction.

The entire disclosure of Japanese Patent Application No. 2009-118343, filed May 15, 2009 and No. 2010-058819, filed Mar. 16, 2010 are expressly incorporated by reference herein.

What is claimed is:

1. A MEMS sensor comprising:
a supporting portion;
a movable weight portion;
a connecting portion that couples the supporting portion with the movable weight portion and is elastically deformable;
a first fixed electrode portion protruding from the supporting portion; and
a first movable electrode portion protruding from the movable weight portion and disposed so as to face the first fixed electrode portion, wherein
the movable weight portion is formed by stacking a conductive layer and an insulating layer in a first direction,
plugs having a larger specific gravity than the insulating layer are embedded in the insulating layer,
the conductive layer is connected to the first movable electrode portion, and
one of the first fixed electrode portion and the first movable electrode portion has a first electrode portion and a second electrode portion in the first direction.

2. The MEMS sensor according to claim 1, wherein
the first electrode portion and the second electrode portion are electrically isolated from each other.

3. A MEMS sensor comprising:
a supporting portion;
a movable weight portion;
a connecting portion that couples the supporting portion with the movable weight portion and is elastically deformable;
a first fixed electrode portion protruding from the supporting portion; and
a first movable electrode portion protruding from the movable weight portion and disposed so as to face the first fixed electrode portion, wherein
the movable weight portion is formed by stacking a conductive layer and an insulating layer in a first direction,
plugs having a larger specific gravity than the insulating layer are embedded in the insulating layer,
the conductive layer is connected to the first movable electrode portion, and
the first fixed electrode portion and the first movable electrode portion have a facing region where electrodes face each other and a non-facing region where electrodes do not face each other.

4. The MEMS sensor according to claim 1, wherein
the first fixed electrode portion and the first movable electrode portion are formed by using the conductive layer and the insulating layer.

5. The MEMS sensor according to claim 4, wherein
the plugs are embedded in the insulating layer in the first direction, and
the plugs are conductive members.

6. The MEMS sensor according to claim 1, wherein
the movable weight portion has a first face whose normal line is in the first direction, and
the plugs are formed to be line-symmetric with respect to both a second direction parallel to the first face and a third direction parallel to the first face and orthogonal to the second direction.

7. The MEMS sensor according to claim 1, wherein
an integrated circuit portion is formed next to the supporting portion, and
the integrated circuit portion is formed by using the conductive layer and the insulating layer.

8. The MEMS sensor according to claim 1, further comprising:
electrode pairs including a second fixed electrode portion protruding from the supporting portion and a second movable electrode portion protruding from the movable weight portion and disposed so as to face the second fixed electrode portion as a pair, wherein
the movable weight portion has a rectangular parallelepiped shape having first and second faces whose normal lines are in the first direction and first to fourth side faces connected to the first and second faces,
at least two of the electrode pairs are formed on the first side face, or at least each of the electrode pairs is formed on both the first side face and the second side face facing the first side face, and
force in a direction parallel to the first and second side faces is detected based on the capacitance difference between two capacitance forming portions.

9. The MEMS sensor according to claim 8, wherein
at least two of the electrode pairs are formed on the third side face orthogonal to the first side face, or at least each of the electrode pairs is formed on both the third side face and the fourth side face facing the third side face, and
force in a direction parallel to the third and fourth side faces is detected based on the capacitance difference between two capacitance forming portions.

10. An electronic apparatus comprising the MEMS sensor according to claim 1.
